(19) United States
(12) Patent Application Publication
(10) Pub. No.: US 2007/0094194 A1
(43) Pub. Date: Apr. 26, 2007

(54) Method for managing an expert behavior-emulation system assisting an operator-controlled-decision system

(75) Inventors: Pavel Zelinsky, Boulder, CO (US); James Dixon, Thornton, CO (US)

Correspondence Address: MERCHANT & GOULD PC, P.O. BOX 2903, MINNEAPOLIS, MN, 55402-0903, US

(73) Assignee: Parascript LLC

(21) Appl. No.: 11/197,558

(22) Filed: Aug. 3, 2005

(51) Int. Cl. G06N 5/02

(52) U.S. Cl. 706/46

(57) ABSTRACT

An expert behavior-emulation system that assists a operator-controlled-decision system, is managed based on group performance results of operators using the systems. The performance results achieved by an expert group of operators and a non-expert group of operators is evaluated. Both groups are using the operator-controlled-decision system assisted by the expert-behavior emulation system to take action on a situation task to produce the performance results. The performance results of the actions taken are grouped according to expert group and non-expert group. A gap is measured which indicates one or more changes in group performance results as a measure of the extent to which the expert behavior-emulation system is contributing to performance results achieved by operators using the operator-controlled-decision system assisted by the expert-behavior emulation system. The expert behavior-emulation may be adjusted, and the gap may be measured again.

### FIELD OF THE INVENTION

This invention relates to a computer system and a computer method for managing an expert behavior-emulation system as it assists an operator-controlled-decision system. More particularly the invention relates to evaluating the gap in performance between best practice operators and other operators in an expert behavior-emulation system assisting an operator-controlled-decision system and managing the expert behavior emulation system based on various gap metrics.

### BACKGROUND OF THE INVENTION

Certain operator-controlled-decision systems interact with human operators to arrive at a final result chosen by the operator in response to input situation data. The operator controlled decisions in such systems are in substance an art form rather than a pure logic process. Some examples of such operator-controlled decision-making systems might be a goods-to-stores allocation system, a student-to-school allocation system, an application of robotic devices to a task or mission, and in general any operator-controlled decision-making system applying allocation of resources to solve a situation using the resources.

Decisions made by human operators in such operator-controlled-decision systems are artful and based on experience of the operator and other intangibles that are not measurable. However, managers of such operator-controlled-decision groups of operators can look at performance metrics resulting from the decisions and tell you who are the best practice, or expert, operators in the group. In other words, while it is not possible to logically emulate a given decision, it is possible to identify who are the best practice, or expert, operators.

If an expert behavior-emulation system is used to assist operators using the operator-controlled-decision system to make better decisions, there remains the need to determine whether or not such an expert behavior-emulation system contributes to the long-term performance of the operator-controlled-decision system. For example, if the operator-controlled-decision system is allocating goods to a chain of stores, and the corporation owning the stores observes that the store revenues improve, how does the corporate owner know that the improvement was due to the addition of the expert behavior-emulation system. From the perspective of the owner, factors such as the economy in general, consumer trends, public events, weather conditions, may be responsible for changes in revenue. The question the owner asks is what value did the expert behavior-emulation system contribute as it assisted the owner's operator-controlled-decision system.

Further, there is a need to determine when the expert behavior-emulation system is performing properly and when it needs to retrained.

It is with respect to these considerations and others that the present invention has been made.

### SUMMARY OF THE INVENTION

In accordance with the present invention the above and other problems are solved by identifying the operators who are the expert operators, setting a results-evaluation criteria based on a metric selected by the owner of the operator-controlled decision system, grouping the past results of an expert group and a non-expert group, also grouping new results from an expert group and a non-expert group after the addition of the expert behavior-emulation system, and finally calculating the gap between the past performance results and new performance results of the expert and non-expert groups. Additional calculations may yield for evaluation other gap metrics such as the change in performance of the experts from past to present, the change in performance of the non-experts from past to present, and the gap or delta improvement, i.e., the reduction in the performance gap between the two groups from past to present. The gap metrics may be reported as a measure of the contribution of the expert behavior emulation system and also may be tested to determine when to retrain the expert behavior-emulation system. In another aspect of the invention, a method for managing an expert behavior-emulation system as it assists an operator-controlled-decision system, collects operator performance results, groups the performance results in two groups, measures the gap in performance results between the groups, adjusts the expert-behavior-emulation system and repeats the collection, grouping and gap measurement.

The performance results of the actions taken by a first group of best-practice operators are combined, and the performance results of the actions taken by a second group of other operators not in the first group are combined. A performance gap is measured that indicates the difference in group performance results of the first group and the second group. The expert behavior-emulation system is adjusted if the system owner chooses, and the acts of collecting, grouping and measuring are repeated in order to measure a new gap indicating a new difference in group performance results of the first group and second group.

One advantage of measuring the performance gap and calculating the various gap-related metrics is that this data should be independent of factors outside the performance of the expert behavior-emulation system. Both groups will have experienced the same outside factors. In other words, the gap and its changes will reflect the contribution of the expert behavior-emulation system only.

These and various other features as well as advantages, which characterize the present invention, will be apparent from a reading the of the following detailed description and a review of the associated drawings.

### BRIEF DESCRIPTION OF THE DRAWINGS

FIG. 1 shows the operational flow of a preferred embodiment of the invention where the gap between expert groups and non-expert groups is evaluated and used to initiate training cycles for the expert behavior-emulation system as necessary.

FIG. 2 illustrates the data and command flow of the expert behavior-emulation system as it interacts with an operator and an operator-controlled-decision system application.

FIG. 3 illustrates the operational flow of the evaluate module 110 in FIG. 1.

FIG. 4 shows the operational flow of the evaluate gap operation 310 in FIG. 3.

FIG. 5 is a performance improvement graph showing the performance of the best practice, or expert, operators and other operators before, during adaptation to, and after the addition of the expert behavior-emulation system to the operator-controlled-decision system.

FIG. 6 shows the operational flow of another preferred embodiment of the invention where the gap between expert groups and non-expert groups is measured, the expert behavior-emulation system is adjust and the gap is remeasured.

### DETAILED DESCRIPTION OF EXEMPLARY EMBODIMENTS OF THE INVENTION

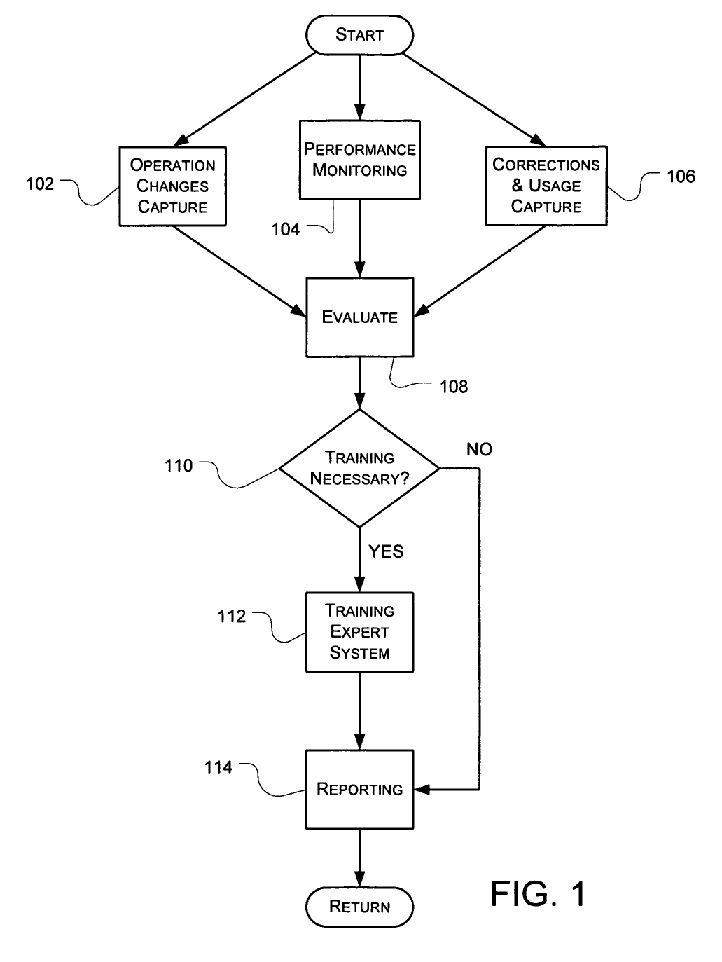

In accordance with one preferred embodiment of the invention, FIG. 1 illustrates the operational flow for capturing data related to the combination expert behavior-emulation system and operator-controlled-decision system. After the data is captured, it is evaluated and, if training is necessary, the expert behavior-emulation system is retrained. If training is not necessary, then a report is generated indicating the present status of the combined systems. This present status is, in effect, a report about the quality or value of the decisions being made as enhanced by the expert behavior-emulation system.

The logical operations of the various embodiments of the present invention are implemented (1) as a sequence of computer implemented acts or program modules running on a computing system and/or (2) as interconnected machine logic circuits or circuit modules within the computing system. The implementation is a matter of choice dependent on the performance requirements of the computing system implementing the invention. Accordingly, the logical operations making up the embodiments of the present invention described herein are referred to variously as operations, structural devices, acts or modules. It will be recognized by one skilled in the art that these operations, structural devices, acts and modules may be implemented in software, in firmware, in special purpose digital logic, and any combination thereof without deviating from the spirit and scope of the present invention as recited within the claims attached hereto.

In FIG. 1 the operational flow begins with three parallel program threads that capture three different types of data. The change capture module 102 captures operational changes made in the operator-controlled-decision system. For example, the quality or criteria of demands to be met by the operator-controlled-decision process might be changed. Also, the assignment of resources to be used in meeting the demands might be changed. In a goods-to-stores allocation system the number of stores might be changed, and the types of product to be allocated to different groups of stores might by changed. Also, module 102 captures (a) entire data situation available to the operator, (b) actions taken by the operator in the operator-controlled-decisions system including keystrokes, mouse movement, clicks, method selection, parameters, data sorting and grouping, etc., and (c) results of those actions, for example, quantity of goods allocated to individual stores in the course of actions taken by the operator.

The performance monitoring module 104 is a performance data capture program thread that is capturing the performance results reflecting the quality of the decisions being made by operators using the operator-controlled-decision system as enhanced by expert behavior-emulation system. The performance result metric or the criteria for selecting performance results may be specified by the owner of the operator-controlled-decision system. The performance results are collected for each operator. Subsequently during evaluation, the operator performance results will be grouped for different groups of operators as described hereinafter. Sometimes, performance results are not observable immediately at the moment of decision-making. For example, allocation of too many swimsuits to a small northern store in spring will result in excessive markdowns later at the end of the summer season and poor performance measured as profit margin. In such cases actual performance evaluation might be postponed and performed later.

Corrections capture module 106 will collect the corrections and usage data provided by the behavior-emulation system. This corrections and usage data is a log kept by the expert behavior-emulation system. The behavior-emulation system logs when a decision by the behavior-emulation system is used and when a decision recommended by the behavior-emulation system is overwritten or corrected by an operator.

Each of the data capture threads 102, 104, and 106 provide data to the evaluate module 108. Evaluate module 108 will be evaluating whether the capture data from each thread represents a condition that requires the expert behavior-emulation system to be retrained. In the case of operation changes capture by change module 102, the evaluate module 108 will be looking for substantive changes to the operator-controlled-decision system. Substantive changes are those that would reflect a change in the parameters of the selected task being processed by the operator-controlled-decision system. For example in the task of allocating goods-to-stores a change in parameters would a be a change in the number of stores, a change in store grouping, a change in the number of operators, etc.

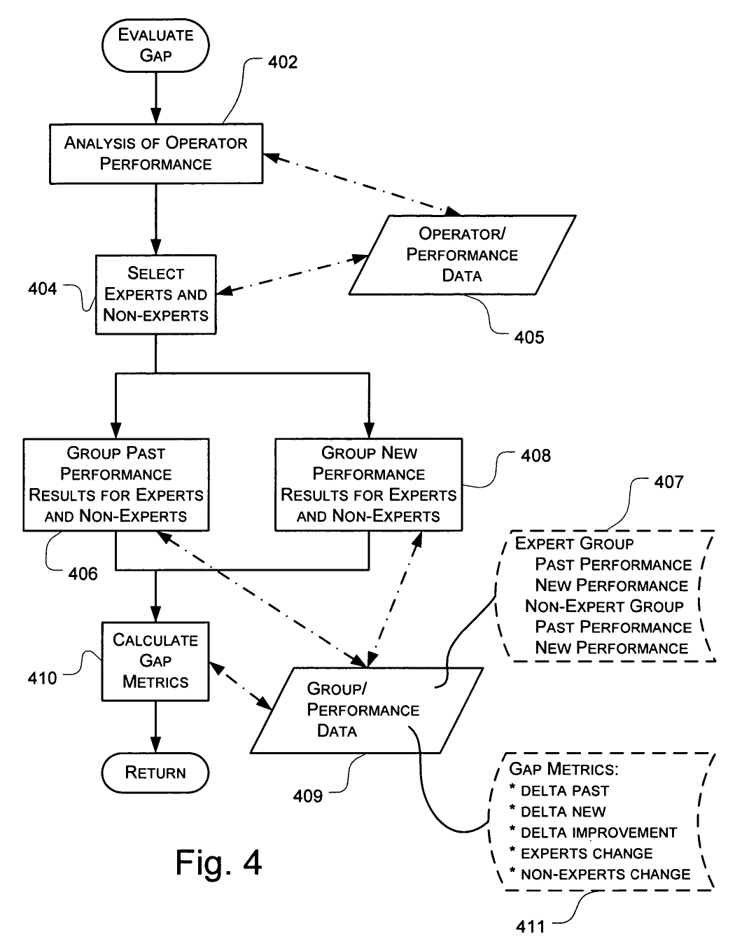

Evaluate module 108 is also monitoring the performance data to look for changes in the performance between a group of expert operators and a group of non-expert operators. This data which reflects a performance gap between the two groups is monitored to detect various gap metrics such as delta past, delta present, delta improvement, experts group performance change, and non-experts group performance change. These gap metrics will be described hereinafter in reference to FIG. 4.

Lastly the evaluate module 108 will evaluate the corrections in usage data from correction capture module 106. This corrections and usage data will be evaluated to see if the volume of corrections is below a predetermined threshold, or if the ratio of corrections to acceptance (usage) decisions by the operators below a predetermined threshold indicating the recommendations of the behavior-emulation system are being used by the operators.

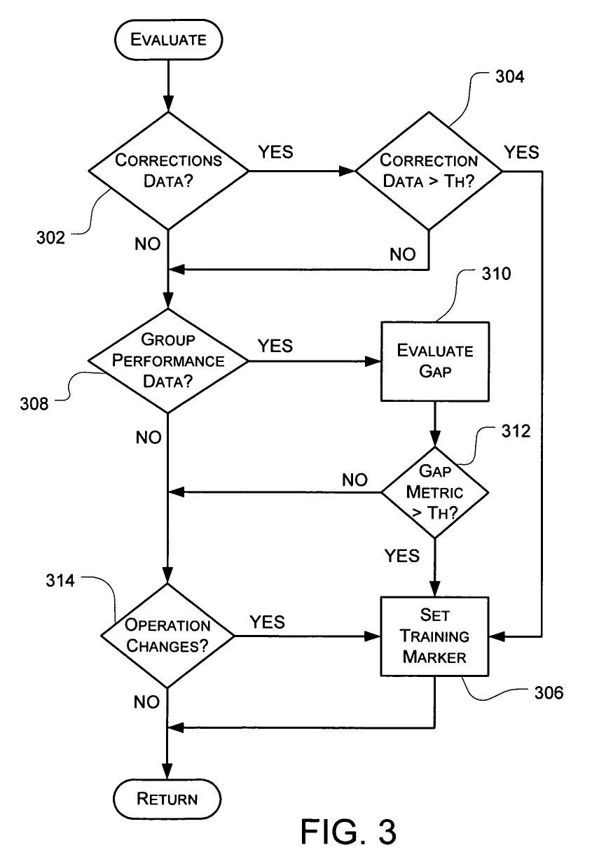

The evaluate module 108 will set a training marker or otherwise indicate that training is necessary if evaluation performed by the module shows that training of the expert behavior-emulation system is required. The evaluate module 108 is illustrated in FIG. 3 and will be described in more detail hereinafter with reference to that Figure.

In FIG. 1 the training necessary operation 110 detects the training marker from evaluate operation 108. If the training marker is detected, the operational flow passes to the training operation 112. This training operation is described in commonly owned patent application Ser. No. 10/976,218 filed Oct. 26, 2004 and entitled “Training a Multi-Dimensional Expert Behavior-Emulation System.” The description of this training operation is incorporated herein by reference.

If the training marker is not detected by the training necessary test operation 110, the operation flow branches NO to reporting operation 114. Reporting operation 114 will generate a report indicating the configuration of the expert behavior-emulation system, the performance of that system according to a business metric set by the owner of the operator-controlled-decision. In the event the operational flow passes through training operation 112 then the reporting operation 114 will report on the new configuration of the expert behavior-emulation system after training.

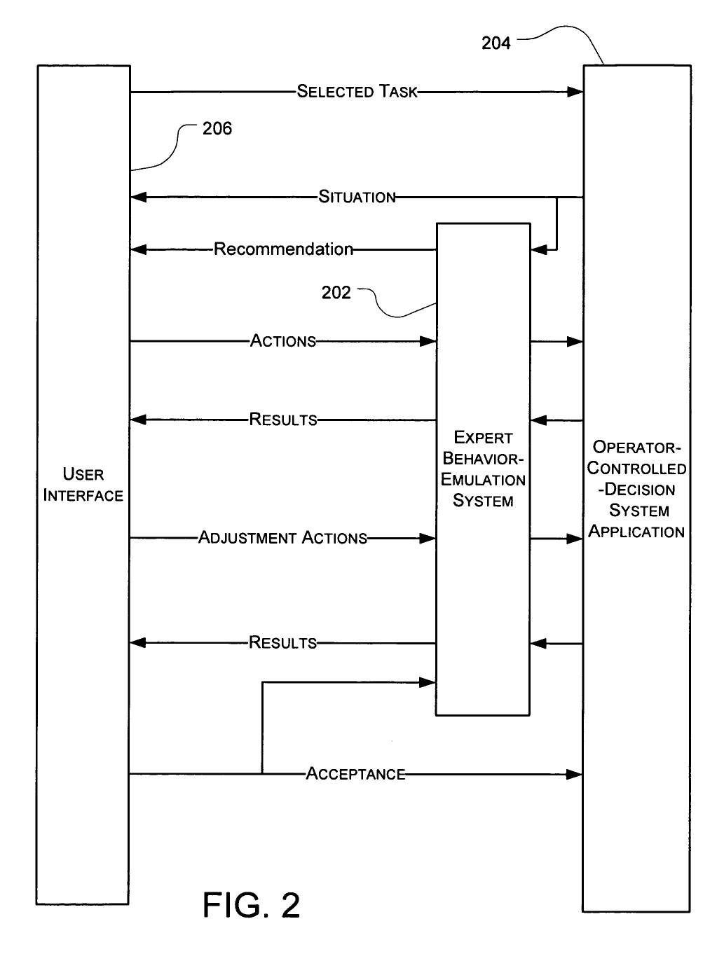

FIG. 2 illustrates the data and command flow between the expert behavior-emulation system (EBMS) 202, an operator-controlled-decision system (OCDS) application 204, and a user interface 206. The user interface 206 is an interface between the user, such as an allocator, and the OCDS running application 204 and the EBMS 202. User interface 206 may be one display with accompanying input devices, or it may be separate displays for each of the OCDS and the EBMS with separate or shared input devices. The operations performed in the various embodiment of the present invention would be performed as a part of the expert behavior-emulation system 202. This expert behavior-emulation system works with the OCDS application 204, but does not require any alteration of the OCDS application to be able to work with that application. In other words the expert behavior-emulation system enhances the operator-controlled-decision system but does not require a redesign of the OCDS application. On the other hand, if the operator-controlled-decision system is changed by the owner of the system then the expert behavior-emulation system will have to be retrained.

The operator in the operator-controlled-decision system works at the user interface 206 to select the task to be performed by the operator-controlled-decision system as assisted by the behavior-emulation system. Situation data related to the selected task is provided to the operator by the OCDS application 204. The situation data is also provided to the expert behavior-emulation system 202. The behavior-emulation system then makes a recommendation to the operator at the user interface. Note that during the data capture phase, when EBES is not trained yet, a recommendation is not provided to the operator and EBES just captures/observes usage of OCDS by the operator. The operator then acts on the situation and recommendation. The actions taken by the operator are passed back to the operator-controlled-decision system application and monitored by the behavior-emulation system. The results produced by those actions are passed back from the OCDS application to the user interface for the operator and also monitored by the behavior-emulation system. At this point the operator may choose to accept the results and will notify the OCDS application of his/her acceptance. Alternatively the operator at the user interface may send back adjustment actions to the OCDS application. These adjustments are monitored by the behavior-emulation system and kept as correction in a log by the behavior-emulation system. The results of these adjustment actions are passed back from the OCDS application to the user interface and are also monitored by the behavior-emulation system. If the user now accepts the results, an acceptance notice is sent from the user interface to the OCDS application 204 and the behavior-emulation system. A description of the expert behavior-emulation system as it works with the OCDS application is described in the commonly owned patent application Ser. No. 10/974,383 filed Oct. 26, 2004, entitled “Multi Dimensional Expert Behavior-Emulation System” and is incorporated herein by reference.

FIG. 3 illustrates the operational flow for the evaluate module 108 in FIG. 1. The evaluate operational flow in FIG. 3 begins with corrections data test operation 302. The corrections data test operation detects whether corrections and usage data has been received from the corrections and usage capture module 106 in FIG. 1. If such data has been received then the operational flow branches yes to see if the quantity of corrections exceeds a threshold. The correction data might include the volume of corrections, the frequency of corrections, or the ratio of corrections to acceptances. Any one of these metrics can be tested against a predefined threshold by corrections data threshold test operation 304. The criteria for setting the threshold is simply a value indicative of the usability of the expert behavior-emulation system. If the number of corrections, the frequency of corrections, or the ratio of corrections to acceptances is too high the behavior-emulation system is not efficient. If the correction data threshold test operation 304 detects the threshold test has been satisfied, the operation flow branches YES from test operation 304 to set operation 306. Set operation 306 sets a training marker indicating the behavior-emulation system should be retrained.

If correction data is not being evaluated or the correction data threshold is not satisfied, then the operation flow will pass to group performance data test operation 308. Group performance test operation 308 detects that the performance monitoring module 104 in FIG. 1 has provided group performance data to evaluate module 108. If group performance data has been received, then the operational flow will branch YES from test operation 308 to the evaluate gap operation 310. Evaluate gap operation 310 will be evaluating the gap between the group performance of expert, or best practice, operators and the group performance of non-expert, or other, operators. The gap or delta in performance between these two groups may be calculated for a past collection of performance data and for a present collection of performance data. The delta improvement between the past gap and the present gap is another gap metric useful in evaluating the behavior-emulation system. The evaluate gap operation 310 is described hereinafter in more detail with reference to FIG. 4.

The gap metric produced by evaluate gap operation 310 is tested against a threshold by gap metric test operation 312. If the gap metric exceed the threshold, then the operation flow branches to set operation 306 that sets the training marker. As discussed above, the training marker will flag to the training system 112 operation in FIG. 1 that the behavior-emulation system needs to be retrained. Typically the gap metric tested against the threshold might be the delta improvement metric. In other words, the gap between the performance in the past and the performance in the present is slight or possibly even negative. In such a situation it would be desirable to retrain the behavior-emulation system.

If the gap metric does not exceed the threshold, then the operation flow branches NO to the operation changes test operation 314. Test operation 314 is detecting whether a substantive change in the operations of the OCDS application has been provided in the operation change data from operation changes module 102 in FIG. 1. If a substantive operation has been detected, the operational flow branches YES to set operation 306 to set the training marker. If a substantive change has not been detected, the operational flow will return to FIG. 1 where the next operation is the training necessary test 110. The training necessary test is, of course, checking for the training marker being set by the set operation 306 in FIG. 3. In FIG. 3 the operation flow from the set training marker also returns to FIG. 1 if a training marker has been set. Once the training marker has been set it does not matter whether it was set because of the corrections data, the gap metric, or a detection of substantive operation changes.

FIG. 4 illustrates the operational flow for the evaluate gap operation 310 in FIG. 3. The evaluate gap operational flow begins at analysis operation 402. Analysis operation 402 analyzes the performance of operators working with operator-controlled-decision system application. The analysis will indicate which operators are the top performers or experts, i.e. have used the best practices to perform the operator-controlled-decision process. The analysis may be performed logically be a computing system analyzing past performance data or alternatively, a manager of the operators may know who are the top performers. Usually, however the computer analysis is more accurate.

Once the analysis of operator performance is complete, select operation 404 separates the operators into two groups: experts and non-experts. This selection may be by choice of the manager who knows the best or top performers in the set of operators. Alternatively a threshold might be set based on results achieved by the operators. For example, the select operation might designate the top 20% of the operators based on results achieved by the operators. Alternatively, the results themselves might be tested against a threshold and those operators having a performance result exceeding the threshold will be designated or selected as the experts. Further, while normally there will be a group of experts, it is also possible to select only the top performer, i.e., a group of one, selected as the group expert in working with the operator-controlled-decision system.

Once operators for the expert group and the non-expert group have been selected, past results operation 406 and present results operation 408 group their results by expert group and non-expert group. The result being monitored depends upon the metric chosen by the owner of the operator-controlled-decision system. The metric might be revenue, volume, turnover or rate of change, or any other metric chosen by the owner. Similarly the results might be summed, averaged, or any other formula-driven process to combine the results of a group.

The present results operation 408 would perform the same operations as the past results operation 406 using the same metric and the same formula-driven combining operation to combine the results. The present results operation will be working on the most recent or current performance results of the expert group and non-expert group. The past results operation 406 will be working on performance results of the two groups sometime earlier. The difference in time between the performance results being grouped is a matter of choice. As the expert behavior-emulation system is installed the past results and present results may be compared every two or three days, weeks, months or every season depending on a time period between a decision and availability of performance results of a decision or a series of decisions. As the system settles out and the operators become used to working with the combined behavior-emulation system and the operator-controlled-decision system, the performance results for today and a week earlier may be compared or the performance results for today and a month earlier may be compared. Also, the type of task being worked with in the operator-controlled-decision system may effect the time period between grouping past results and grouping new results.

Calculate operation 410 retrieves the group performance data and calculates the gap or delta between group results of experts and non-experts. The gap metrics calculated by operation 410 also include a delta improvement calculation which would be the reduction in gap between experts and non-experts from past performance to present or new performance. Another metric that can be prepared is the delta or change in performance of the experts from past to present. Likewise the change in performance of the non-experts can be calculated from past to present.

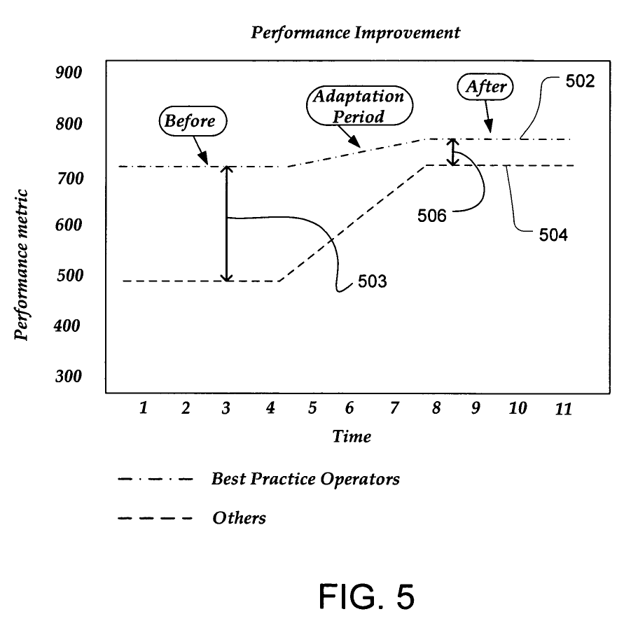

FIG. 5 is an exemplary diagram of performance improvement when the expert behavior-emulation system begins working with the operator-controlled-decision system application. The performance improvement chart is typical of performance results achieved by the addition of the expert behavior-emulation to an operator-controlled-decision system application. The vertical axis is a performance metric chosen by the owner of the operator-controlled-decision system. The horizontal axis are time intervals indicating when performance results have been grouped.

Line 502 illustrates the results achieved by the expert group. Line 504 illustrates results achieved by the non-expert group. Gap 503 is the gap between the expert group and the non-expert group before addition of the expert behavior-emulation system. The expert behavior-emulation system is added to the operator-controlled-decision system at time period 4 on the chart. By time period 8 the improvement in performance results has settled out as the expert and non-expert groups adapt to the use of the expert behavior-emulation system recommendations. Gap 506 in the performance results between the expert group and the non-expert group is measured at a time after the operators have adjusted to the addition of the expert behavior-emulation system.

Three things are notable about the performance improvement in this exemplary chart. First, the gap in performance between the expert and the non-experts is greatly reduced (i.e., the gap 506 is much smaller than the gap 503). Second, the performance results achieved by the non-expert group have approached the performance results achieved by the expert group before implementation of the expert behavior-emulation system. Third and rather interesting, the performance of the expert group has also improved by the addition of the expert behavior-emulation system. This would not have been expected since the expert behavior-emulation system was trained based on the performance of the expert group. Apparently, the expert behavior-emulation system even reduces bad choices by the expert group, or because of time saving, allows experts to perform deeper data analysis and make even better decisions.

Using the above gap metrics, the gap metric test operation 312 (FIG. 3) can test a selected gap metric against a threshold determine whether to cause the set training marker operation 306 to set a training marker. When the training marker is set, training module 112 (FIG. 1) will retrain the expert behavior-emulation system as described above. For example, if the 506 (FIG. 5) is increasing, the gap metric test operation 312 would detect the gap 506 is too large and cause the training marker to be set. Alternatively, if the delta improvement between a past time and a present time is negative are not as large as expected per a predefined threshold, the gap metric test operation would cause the training marker to be set. It will be apparent to one skilled in the art that any of the gap metrics might be used with a selected threshold in test operation 312 to set the training marker.

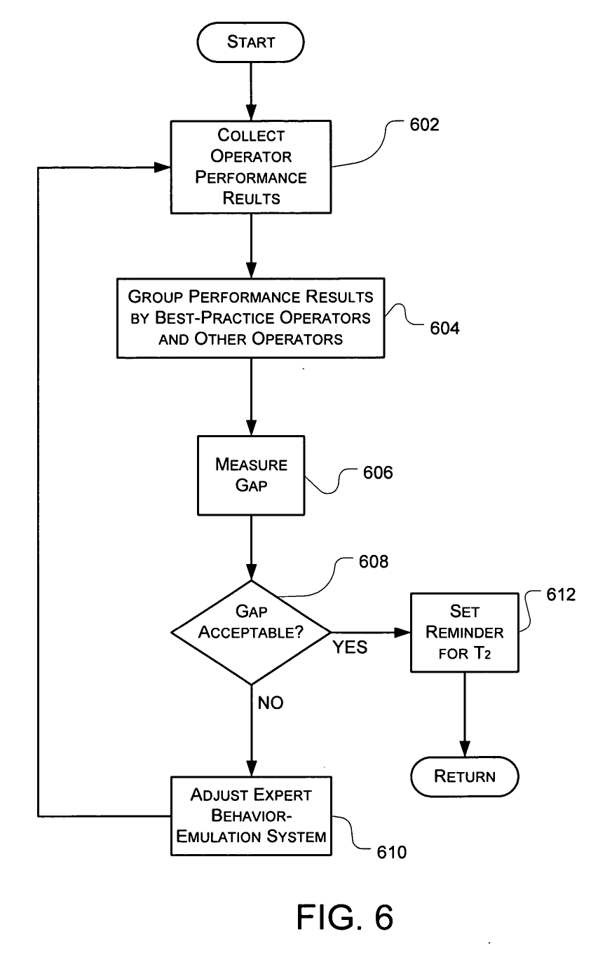

Another preferred embodiment of the invention is illustrated in FIG. 6 where an operator-controlled-decision system assisted by expert-behavior emulation system is managed to improve performance results of operations using the combined systems. The management operational flow begins with collect operation 602 collecting the performance results of each operator over a predetermined time interval. Group operation 604 groups the performance results into two groups. A first group of results contains the combined results of those operators deemed to be the best-practice operators. These best-practice operators are the operators that have proved by a history of performance that they make good decisions using the combined operator-controlled-decision system and the expert-behavior emulation system. A second group of operators includes all other operators not in the first group.

Once the performance results have been combined for each group, measure operation 606 measures the gap or difference in group performance results for the two groups. Gap test operation detects whether the gap is acceptable. If the gap is acceptable, the operation flow branches YES to set operation 612. Set operation 612 sets a reminder to start the manage operational flow in FIG. 6 after a time interval T₂. Thus, the performance of the two groups and the gap between them will be periodically measured. What is an acceptable gap and the period between measurements may be adjusted by the owner of the combined systems.

If the performance gap between the two groups is not acceptable, i.e. for example, the difference in performance results between the two groups is too large, the operational flow branches NO to adjust operation 610. Adjust operation 610 would trigger a training of the expert behavior-emulation system. Alternatively adjust operation 610 may select different operators for the two groups and then retrain the expert behavior-emulation system.

In another embodiment, gap test operation 608 might be looking for a change in the gap or a rate of change in the gap. Accordingly, if the gap was decreasing each measurement cycle through the operational loop that includes operations 602, 604, and 606, then the gap test operation would indicate an acceptable result. Alternatively, the rate of change over multiple successive measurement cycles could be tested for acceptability by gap test operation 608. It will be appreciated by one skilled in the art that the owner of the combined system might elect many variations and combinations of the above described test operations.

While the invention has been particularly shown and described with reference to preferred embodiments thereof it will be understood by those skilled in the art that various other changes in form and details may be made therein without departing from the spirit and scope of the invention.

What is claimed is:

1. A method for managing an expert behavior-emulation system that assists an operator-controlled-decision system, the method comprising:
evaluating performance results achieved by an expert group of operators and a non-expert group of operators, both groups using the operator-controlled-decision system assisted by the expert-behavior emulation system to take action on a situation task to produce the performance results;
grouping the performance results of the actions taken by the expert group and the non-expert group; and
generating a gap metric indicating one or more changes in group performance results as an measure of the extent to which the expert-behavior-emulation system is contributing to performance results achieved by operators using the operator-controlled-decision system assisted by the expert-behavior emulation system.

2. The method of claim 1 further comprising:
reporting the gap metric to an owner of the operator-controlled-decision system thereby indicating to the owner the contribution of the expert emulation-behavior system.

3. The method of claim 1 further comprising:
evaluating the gap metric to determine whether or not it is necessary to retrain the expert emulation-behavior system; and
training the expert behavior-emulation system if training is necessary.

4. The method of claim 1 wherein the act of evaluating comprises:
selecting the group of expert operators and non-expert operators based on operator/performance data and a predetermined performance metric;
grouping past performance results for the expert group and the non-expert group; and
grouping new performance results for the expert group and the non-expert group.

5. The method of claim 4 wherein the act of generating a gap metric comprises:
calculating a past gap as the difference in past performance results between the expert group and the non-expert group;
calculating a new gap as the difference in new performance results between the expert group and the non-expert group;
calculating a delta improvement as the difference between the past gap and the new gap.

6. The method of claim 5 wherein the past performance results are captured when the expert behavior-emulation system is not assisting the operator-controlled-decision system and the new performance results are captured when expert behavior-emulation system is assisting the operator-controlled-decision system.

7. The method of claim 5 wherein the past performance results are captured at a past time when the expert behavior-emulation system is assisting the operator-controlled-decision system and the new performance results are captured at a present time when the expert behavior-emulation system is assisting the operator-controlled-decision system.

8. The method of claim 1 wherein the gap metric is the difference between performance results of the expert group at a past time and a present time.

9. The method of claim 1 wherein the gap metric is the difference between performance results of the non-expert group at a past time and a present time

10. The method of claim 1 wherein the group of experts is a group of best-practice operators selected by an owner of the operator-controlled-decision system.

11. The method of claim 1 wherein the group of experts is a single top-performing operator.

12. A method for managing an expert behavior-emulation system that assists a operator-controlled-decision system, the method comprising:
collecting performance results achieved by actions taken by each operator when using the operator-controlled-decision system assisted by the expert-behavior emulation system to take action on a situation task;
grouping the performance results of the actions taken by a first group of best-practice operators and grouping the performance results of the actions taken by a second group of other operators not in the first group;
measuring a gap indicating the difference in group performance results of the first group and the second group;
adjusting the expert behavior-emulation system; and
after the act of adjusting, repeating the acts of evaluating, grouping and measuring as a new measurement cycle in order to measure a new gap indicating a new difference in group performance results of the first group and second group.

13. The method of claim 12 wherein the act of adjusting comprises:
training the expert behavior emulation system.

14. The method of claim 12 wherein the act of adjusting comprises:
selecting a new group of best-practice operators for the first group; and
training the expert behavior emulation system based on the behavior of the new group of best practice operators.

15. The method of claim 12 wherein the act of adjusting adjusts the time interval between measurement cycles.
